(19) United States
(12) Patent Application Publication
(10) Pub. No.: US 2024/0116202 A1
(43) Pub. Date: Apr. 11, 2024

(54) SKATE SHAPE SANDPAPER CUTTER

(71) Applicants: Rangel De Souza Maria, Tubarão - Santa Catarina (BR); Vitor Florentino Bento, Tubarão - Santa Catarina (BR); Luiz Carlos Pozza, Tubarão - Santa Catarina (BR); Ricardo Cardoso Pessoa, Tubarão - Santa Catarina (BR); Braulio Da Silva Machado, Tubarão - Santa Catarina (BR)

(72) Inventors: Rangel De Souza Maria, Tubarão - Santa Catarina (BR); Vitor Florentino Bento, Tubarão - Santa Catarina (BR); Luiz Carlos Pozza, Tubarão - Santa Catarina (BR); Ricardo Cardoso Pessoa, Tubarão - Santa Catarina (BR); Braulio Da Silva Machado, Tubarão - Santa Catarina (BR)

(21) Appl. No.: 17/963,543

(22) Filed: Oct. 11, 2022

(51) Int. Cl. B26B 5/00

(52) U.S. Cl. CPC B26B 5/005; A63C 17/017

(57) ABSTRACT

A device developed specifically to perform adhesive sheet cutting operation, with one antiskid face (Sandpaper), which is applied over a Skateboard Shape upper face. It is a grip (E1), in which rear end a geometric volume (V1) is formed, which upper face (F1) is bent downward; and between bent face (F1) highest region and grip (E1) rear end upper corner is formed by a recess (R1) with ‘C’ letter shape cross-section, and a knife end (N1) is slightly projected beyond recess (R1), limits, standing over bent face (F1) region.

### BACKGROUND OF THE INVENTION

### Field of the Invention

Present invention is related to a device developed specifically to perform adhesive sheet cutting operation, with one antiskid face (Sandpaper), which is applied over a Skateboard Shape upper face, which is a board assembled on wheels, and that is designed to practice the sport with the same name (skate).

What is more, present Cutter provides sandpaper cutting operation around the Shape edge with significant agility, precision and safety, thus making operation more convenient and practical.

### Description of the Related Art

As it is widely know, Skate is a widely disseminated sport worldwide, which equipment includes a small board, which is popularly known as ‘Shape’, which is assembled over two axes, each one with two wheels, and such equipment is known as Skateboard. Thus, Skate rider shall climb on Shape abovementioned, and supporting one his/her feet on the floor, Skateboard shall be driven in one direction, so that maneuvers can be performed. On the other hand, as Skateboard Shape is usually made of laminated wood or another material with compatible rigidity, which at first has a flat surface, so that, in such condition, it is hard for the sports person to keep his/her feet satisfactorily adhered on Shape surface, and he/she can slip involuntarily, damaging maneuvers, and even causing accidents, among other issues. With the goal of solving such issues, an adhesive sheet was developed some time ago, for application on Shape upper part, and such sheet upper surface is formed by a rough and adhering material, called ‘Sandpaper’; and Sandpaper abovementioned is stuck on Shape due to is lower face adhesive effect, which has an adhesive substance. Sandpaper application on Shape is performed manually; thus Sandpaper sheet is supplied with rectangular shape, slightly larger than the Shape, therefore, upon its application on Shape, Sandpaper abovementioned shall be cut around Shape edges, removing the excess, and thus it has exact Shape size and format.

On the other hand, so far, Sandpaper cutting around the Skateboard Shape has been performed in improvised way, as no specialized tool is known for that end. Thus, what has been done, so far, is that upon Sandpaper application on Shape, a cutting blade has been used, like a single knife and holding is manually, it is slided around the Shape edge, in an adequate angle of attach, cutting thus the excess of Sandpaper abovementioned. Such operation has significant issues, especially related to safety, as the user holds the knife directly in his/her hands, being exposed to accidents with the knife, subject to cutting him/herself, which takes place quite often. What is more, the act of holding the knife with the hands does not assure it remains in the same angle during all cutting path around the Shape edge, resulting in an uneven cut, with regions where the cut enters more in Shape edge, and regions where it enters less, providing an unpleasant aesthetic result.

### SUMMARY OF THE INVENTION

With the goal of solving such issues, present invention has been developed, in which a manually operated device has been designed, especially conceived to perform Sandpaper cutting around Skateboard Shape edge. Therefore, device abovementioned includes a grip, and inside it there is a knife housed longitudinally, which is projected in one end of grip abovementioned, and in this end, grip body has adequate shape to lean on and adapt to Skateboard Shape edge, so that, as it slides around Shape edge, the knife still forms the same angle with Shape, assuring cutting uniformity; and the grip assures total safety to user, as direct manual contact with knife is never required.

It should also be noted that present Cutter is provided in two execution forms, one simplified construction form, with fixed knife, and a more complex construction form, including cutting knife retracting feature.

### BRIEF DESCRIPTION OF THE DRAWINGS

For present invention better understanding, its detailed description is provided as follows, referring to drawings attached, whereas:

FIG. 1 shows the Cutter execution first form in rear assembled view;

FIG. 2 shows the Cutter execution first form in rear exploded view;

FIG. 3 shows the Cutter execution first form in front assembled view;

FIG. 4 shows the Cutter execution first form in front exploded view;

FIG. 5 shows the Cutter execution first form in upper view;

FIG. 6 shows the Cutter execution first form in lower view;

FIG. 7 shows the Cutter execution first form in side assembled view;

FIG. 8 shows the Cutter execution first form in side exploded view;

FIG. 9 shows the Cutter execution first form in rear assembled view;

FIG. 10 shows the Cutter execution first form in rear exploded view;

FIG. 11 shows the Cutter execution first form in front assembled view;

FIG. 12 shows the Cutter execution first form in front exploded view;

FIG. 13 shows a Shape in upper view, representing the first Cutter execution form placed on its edged, performing Sandpaper cutting;

FIG. 14 shows a Shape in cross-section cut, representing the first Cutter execution form placed on its edged, performing Sandpaper cutting;

FIG. 15 shows the Cutter execution second form in rear assembled view;

FIG. 16 shows the Cutter execution second form in rear exploded view;

FIG. 17 shows the Cutter execution second form in side assembled view;

FIG. 18 shows the Cutter execution second form in side exploded view;

FIG. 19 shows the Cutter execution second form in upper view; and

FIG. 20 shows the Cutter execution second form in rear view.

### DETAILED DESCRIPTION OF THE SEVERAL EMBODIMENTS

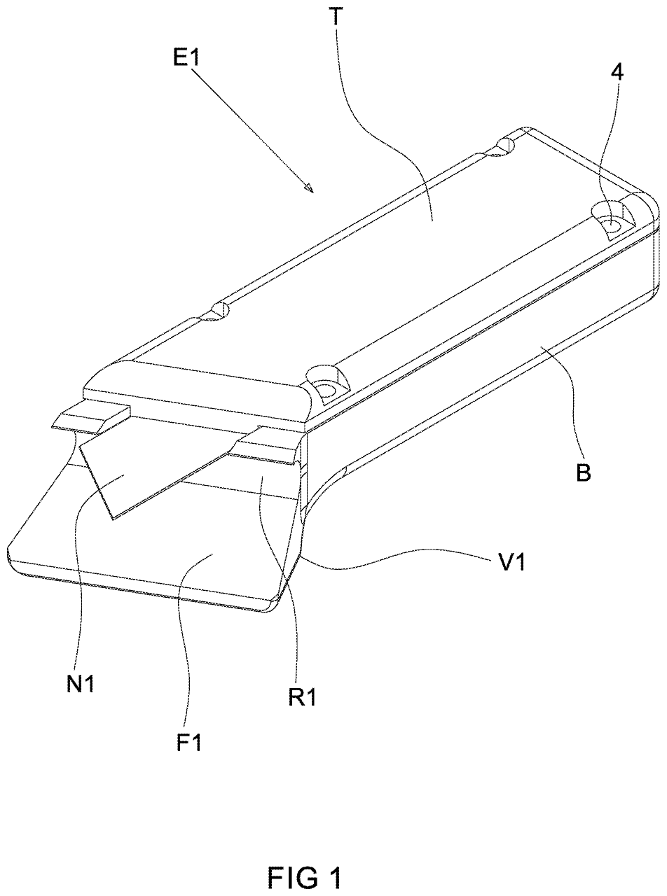

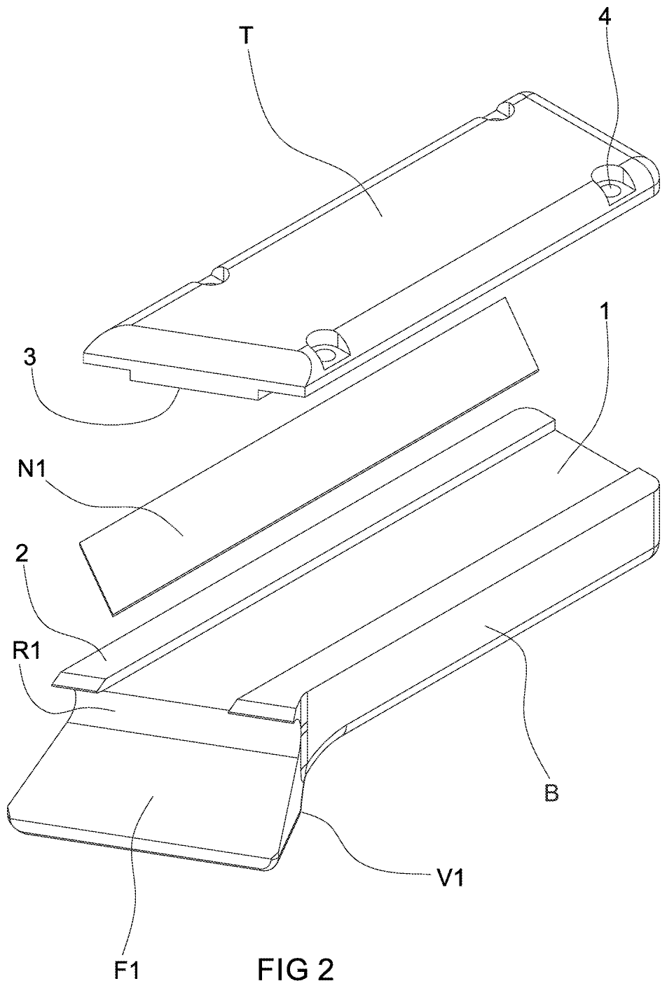

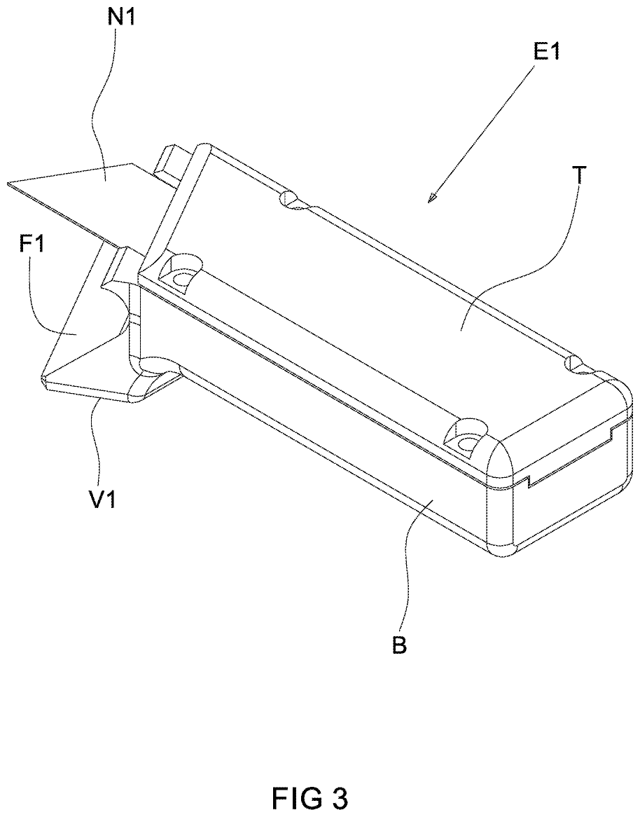

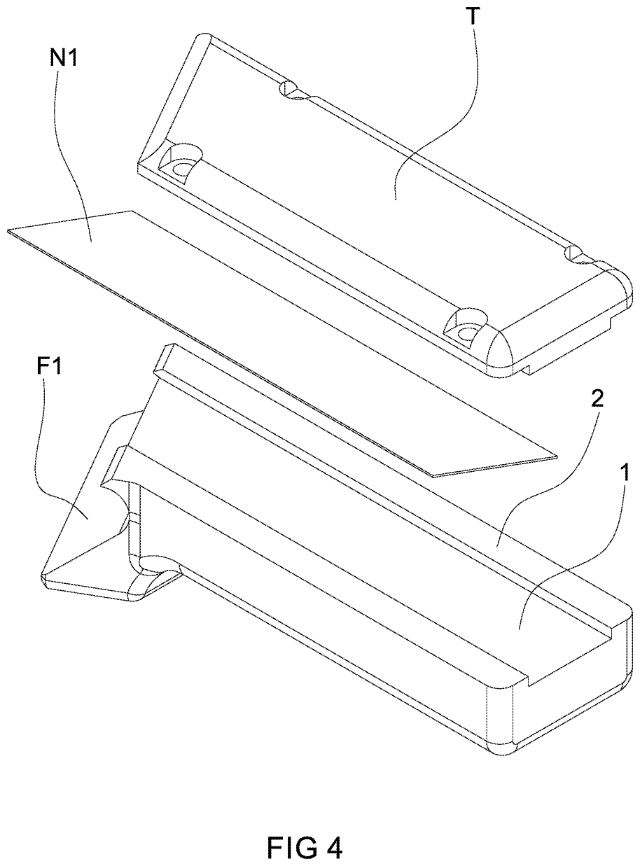

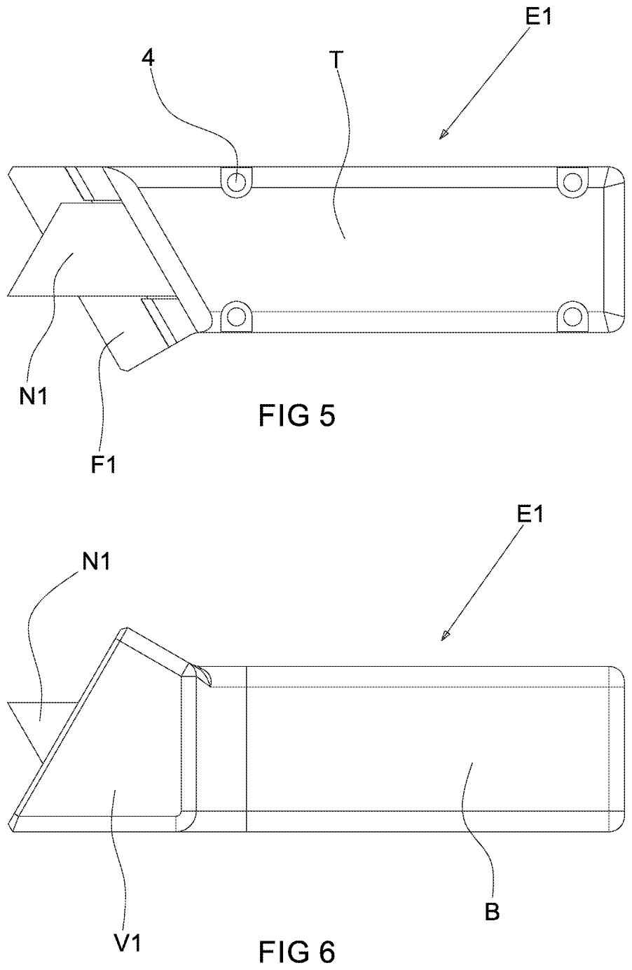

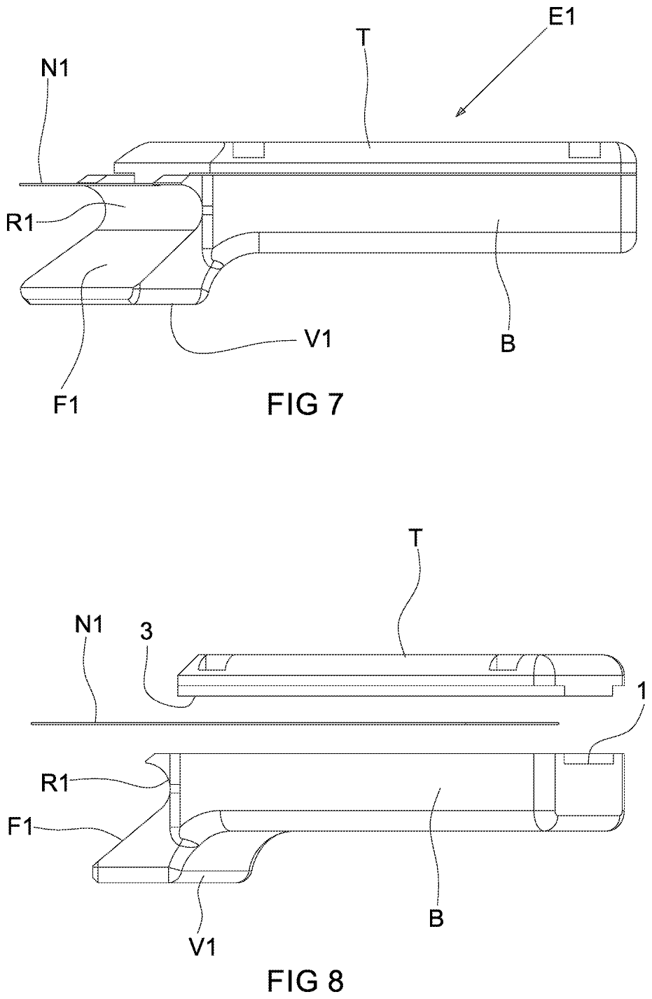

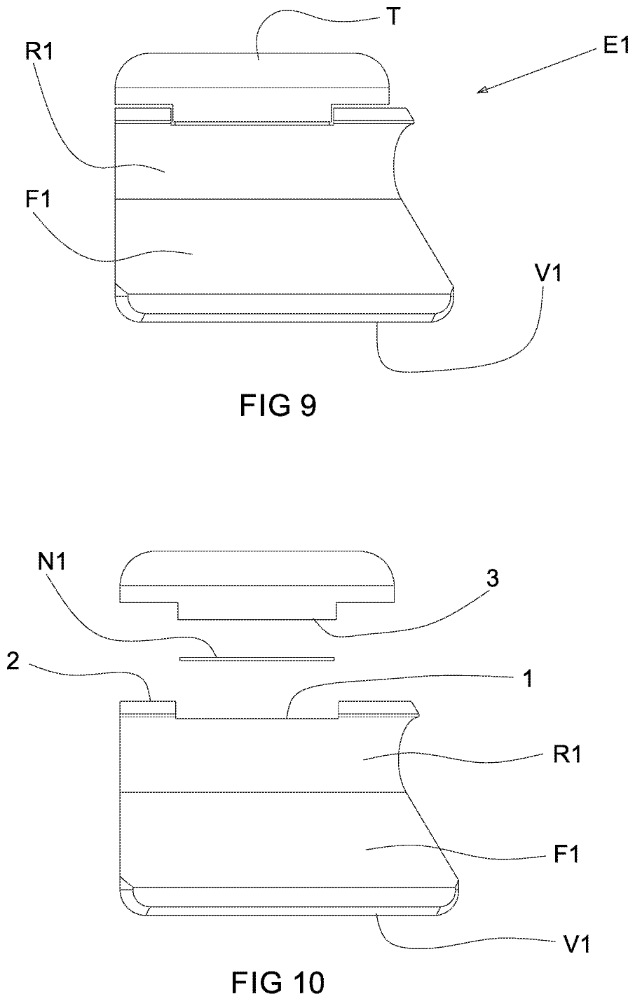

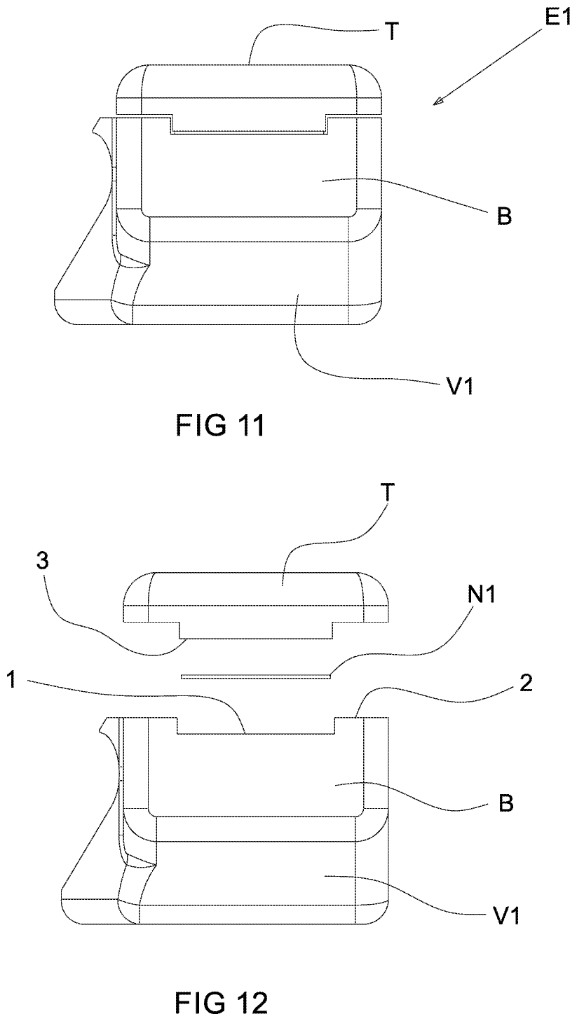

According to illustrations provided, more specifically with reference to FIGS. 1 to 14, present invention: SKATEBOARD SHAPE SANDPAPER CUTTER includes at first one grip (E1), made of plastic material—preferably rubber—or another material with compatible characteristics. Grip abovementioned (E1) is comprised by one parallelepiped elongated block (B) with round corners—but other geometric shapes are possible, even ergonomic ones—And, in upper part, block (B) abovementioned as a flat longitudinal recess (1), provided between two longitudinal elevated and flat edges (2), over which a lid (T) is assembled, in which lower face a flat projecting area is formed (3) with corresponding shape and dimensions to block (B) recess (1). And lid (T) has bores (4) for fastening to Block (B) by means of screws, among other fastening possibilities.

On the other hand, as provided clearly in FIG. 5, block (B) forms and oblique angle in relation to its length direction, and in this end, more specifically in lower corner region, a lower geometric volume (V1) is formed, which lower face (F1) is provided bent down. And bent face (F1) abovementioned highest region and higher corner of this block (B) end is formed by a return (R1) with letter ‘C’ shape cross-section.

On the other hand, inside block (B) recess (1), a knife (N1) is installed, with matching shape and sharp end, which is placed in order to project slightly beyond limits of recess (R1), remaining thus over the region of bent face (F1) of geometric volume (V1). Then, in this condition, lid (T) is installed over block (B), so that lid (T) projection (3) presses knife (N1) inside the recess (1), enabling its fastening.

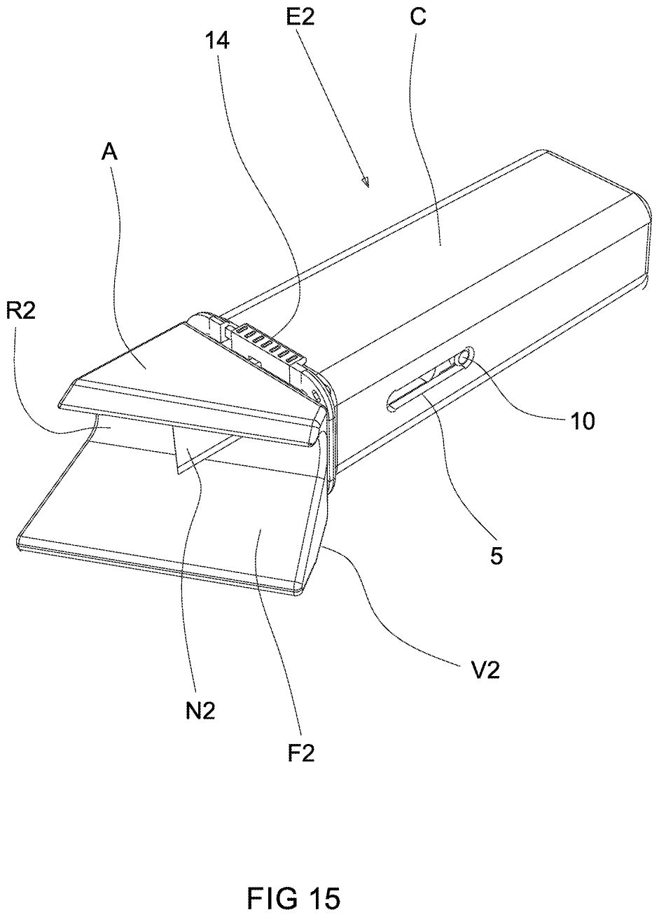

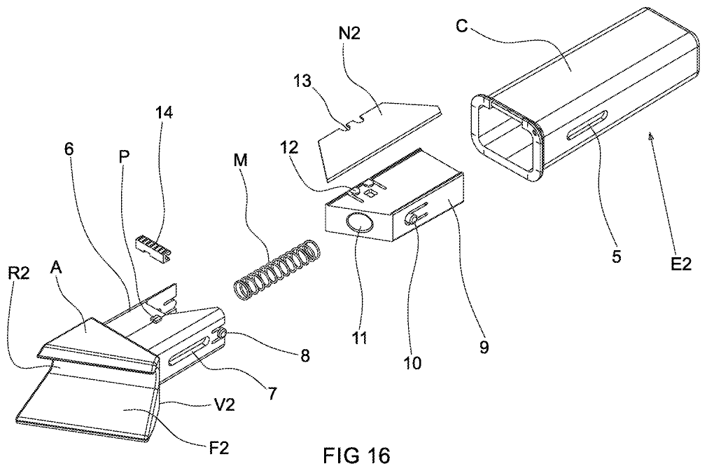

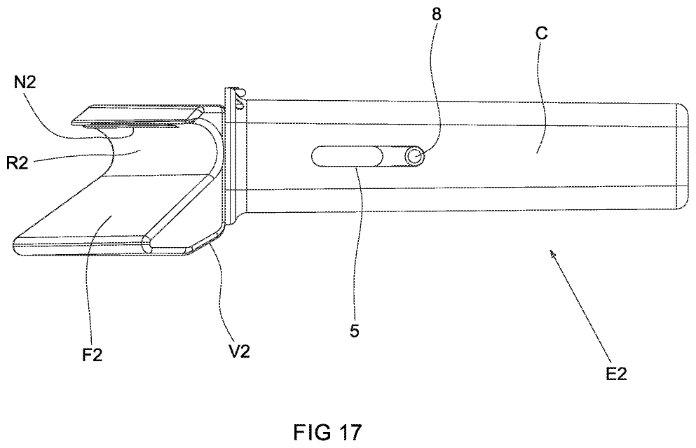

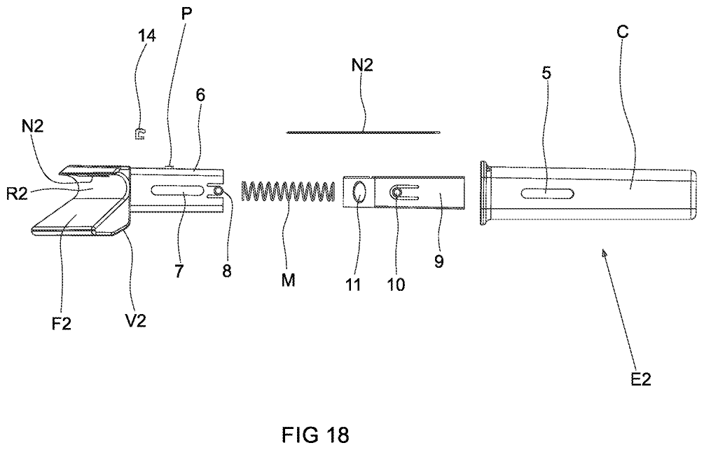

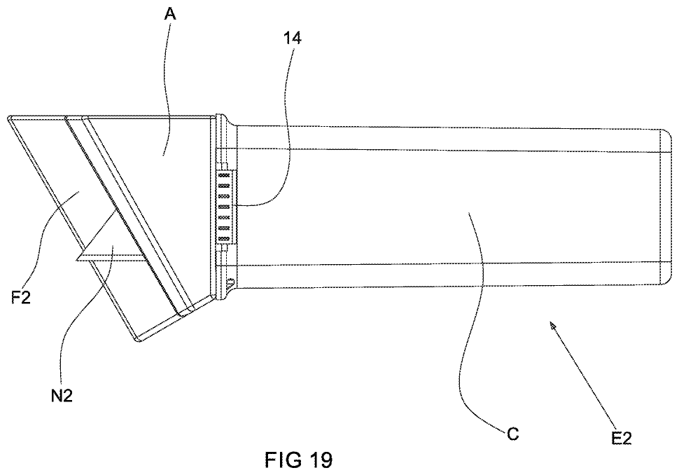

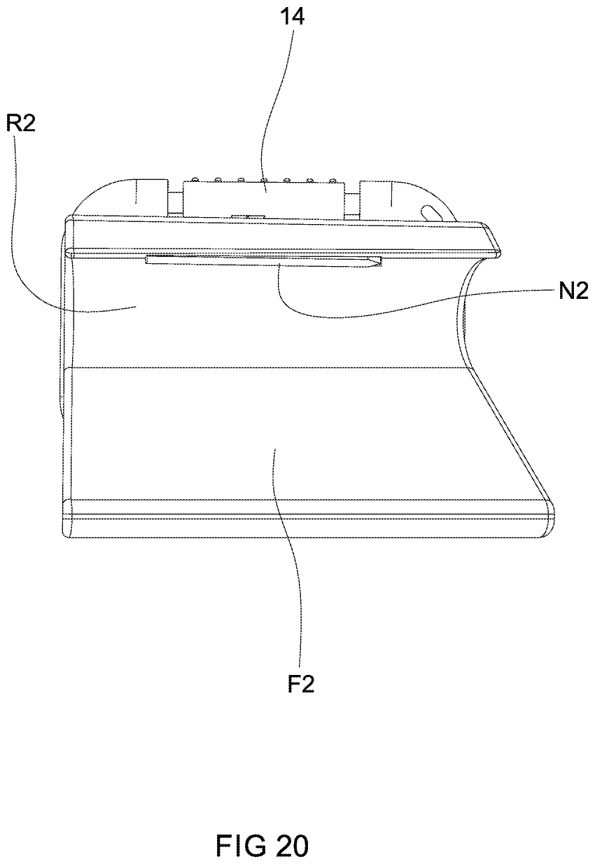

On the other hand, FIGS. 15 to 20 provide a second form of executing present SKATEBOARD SHAPE SANDPAPER CUTTER, which includes grip (E2), formed at first by a parallelepiped format tubular cover (C), which has longitudinal tear (5) in both side walls. On the other hand, lower geometric volume (V2) is formed in a rear block (A), and also has upper face (F2) bent downwards, and also has a return (R2) with letter ‘C’ shape cross-section. Thus, in rear block front face (A), a tubular segment (6) is formed, of rectangular cross-section, with recesses (7) and guide pins (8) in both side faces; and with a small parallelepiped projection (P) in its upper face. And tubular segment (6) abovementioned is inserted sliding inside tubular over (C), so that guide pins (8) fit and operate along such tears (5) of tubular cover (C) abovementioned. And, inside tubular segment (6) abovementioned, a small trapezoidal shape box (9) is assembled, which has side pins (10) to lock inside tubular segment (6); it has in its rear face a cavity (11) to fit a pressure spring (M), and has in its upper face means (12) to lock a knife (N2), which on the other hand is equipped with cuts (13) to lock in such means (12); and knife (N2) rear end passes through a splice under such recess (R2) upper corner. Finally, in tubular cover (C) rear upper edge, a lock (14) is fastened, which is displaced sideways, forming an obstacle to tubular segment (C) projection (P), enabling locking between tubular cover (C) and tubular segment (6) abovementioned.

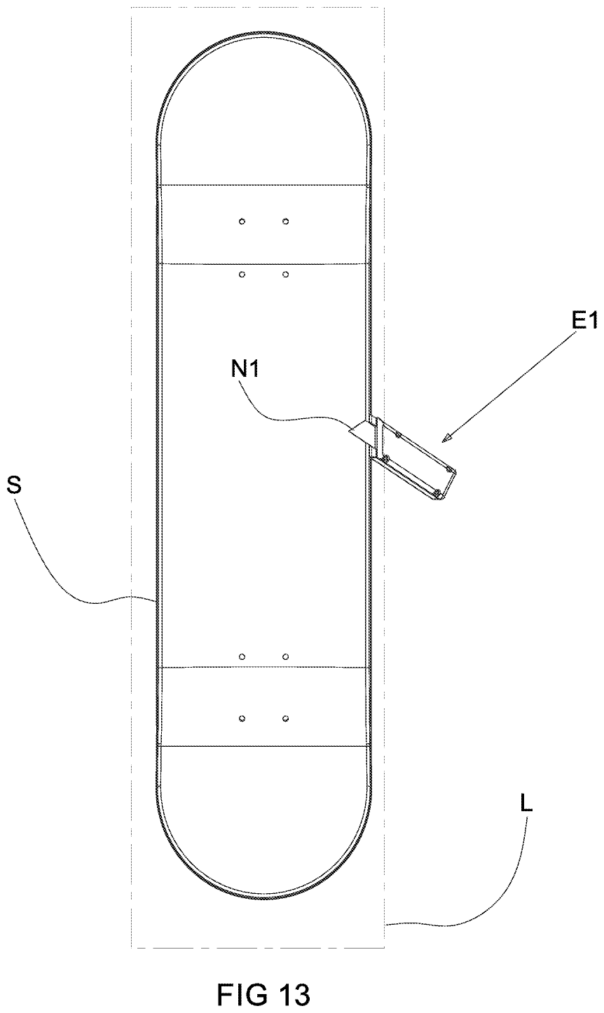

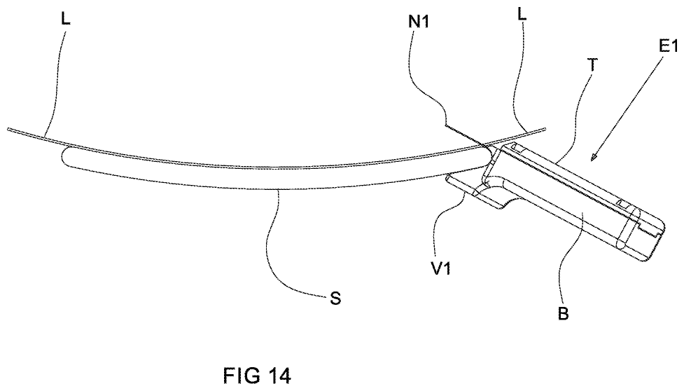

Present SKATEBOARD SHAPE SANDPAPER CUTTER usage and operation are simple and practical. And, as shown by FIGS. 13 and 14, as sandpaper (L) is applied and fastened—by means of its adhesive face—over Skateboard Shape (S) upper face, holding present Cutter by means of its grip (E1), the bent face (F1) of geometric volume (V1) must stand against Shape (S) edge region lower face, and at the same time, fit such recess (R1) against Shape (S) round edge, thus knife (N1) is placed slightly bent over the sandpaper (L), in a position that enables cutting by knife (N1) abovementioned; and so that, as present Cutter is slid along all Shape (S) edge, always keeping contact between Cutter recess (R1) and Shape (S) edge, knife (N1) abovementioned performs sandpaper (L) cutting, complying accurately with Shape (S) edge format.

Concerning tool related to second execution form of present SKATEBOARD SKATE SANDPAPER CUTTER, its usage for sandpaper (L) cutting feature in Shape (S) is identical to first execution form abovementioned, however, knife (N2) is exposed or retracted by means of longitudinal sliding motion of tubular segment (6) inside tubular cover (C), therefore, whenever Cutter is not being used, knife (N2) can be retracted inside tubular segment (6), aiming at greater safety to user. It shall also be noted that spare knives (N2) can be stored inside the box (9), thus keeping them for later replacements is more convenient.

Present SKATEBOARD SHAPE SANDPAPER CUTTER can have variations in its element formats and proportions, as well integral part materials, as long as specific characteristics are observed, and that are essential to its performance.

What is claimed is:

1) A skateboard shape sandpaper cutter comprising:
a grip (E1), in which rear end a geometric volume (V1) is formed, which upper face (F1) is bent downward; and between bent face (F1) highest region and grip (E1) rear end upper corner is formed by a recess (R1) with ‘C’ letter shape cross-section, and a knife end (N1) is slightly projected beyond recess (R1), limits, standing over bent face (F1) region.

2) The skateboard shape sandpaper cutter according to claim 1, wherein the fact grip (E1) is comprised by one parallelepiped block (B) elongated, in which upper face a flat longitudinal recess is formed (1), between two longitudinal elevated and flat edges (2), over which a lid (T) is assembled, in which lower face a flat projecting area is formed (3) with shape and dimensions corresponding to block (B) recess (1).

3) The skateboard shape sandpaper cutter according to claim 2, wherein the lid (T) is equipped with bores (4) for fastening to Block (B) through screws.

4) The skateboard shape sandpaper cutter according to claim 2, wherein the block (B) rear end face forms an oblique angle in relation to its length direction.

5) The skateboard shape sandpaper cutter according to claim 1, wherein the inside block (B) recess (1), a knife (N1) is installed, which shape corresponds to recess (1) abovementioned, and has sharp end.

6) The skateboard shape sandpaper cutter according to claim 2, wherein the lid (T) presses knife (N1) inside recess (1), enabling its fastening.

7) The skateboard shape sandpaper cutter according to claim 1, wherein the grip (E1) alternatively presents ergonomic geometric shape.

8) The skateboard shape sandpaper cutter according to claim 1, wherein the grip (E2) is formed by a tubular cover (C).

9) The skateboard shape sandpaper cutter according to claim 8, wherein the tubular cover (C) is equipped with longitudinal tear (5) in both side walls.

10) The skateboard shape sandpaper cutter according to claim 1, wherein the lower geometric volume (V2), including its upper face (F2) bent downward and recess (R2) with letter ‘C’ shape cross-section are formed in a rear block (A), in which front face a tubular segment (6) is formed, of rectangular cross-section, which is equipped with recesses (7) and guide pins (8) in both side face, and is equipped with a small parallelepiped projection (P) in its upper face.

11) The skateboard shape sandpaper cutter according to claim 8, wherein the tubular segment (6) abovementioned is inserted sliding inside tubular over (C), so that guide pins (8) fit and operate along such tears (5) of tubular cover (C) abovementioned.

12) The skateboard shape sandpaper cutter according to claim 10, wherein the inside tubular segment (6) a small trapezoidal shape box (9) is assembled, which has side pins (10) to lock inside tubular segment (6); and box represents in its rear face a cavity (11) for pressure spring fitting (M); and presents in its upper face, means (12) to lock a knife (N2), which is equipped with cuts (13) to lock in such means (12).

13) The skateboard shape sandpaper cutter according to claim 1, wherein the knife (N2) rear end passes through a splice present under return (R2) upper corner.

14) The skateboard shape sandpaper cutter according to claim 8, wherein the tubular cover (C) rear upper edge, a lock (14) is fastened, which is displaced sideways, forming an obstacle to tubular segment (C) projection (P), enabling locking between tubular cover (C) and tubular segment (6).

15) The skateboard shape sandpaper cutter according to claim 8, wherein the knife (N2) is exposed or retracted by means of tubular cover (6) longitudinal sliding motion inside tubular cover (C).

16) The skateboard shape sandpaper cutter according to claim 12, wherein the box (9) is a container to keep spare razor blades (N2).
